(19) United States
(12) Patent Application Publication
(10) Pub. No.: US 2010/0239495 A1
(43) Pub. Date: Sep. 23, 2010

(54) Hydride composite and preparation process of hydrogen gas

(75) Inventor: Mitsuru Matsumoto, Nisshin-shi (JP)

Correspondence Address: OLIFF & BERRIDGE, PLC, P.O. BOX 320850, ALEXANDRIA, VA, 22320-4850, US

(73) Assignee: KABUSHIKI KAISHA TOYOTA CHUO KENKYUSHO, AICHI-GUN (JP)

(21) Appl. No.: 12/659,122

(22) Filed: Feb. 25, 2010

(30) Foreign Application Priority Data
Mar. 18, 2009 (JP) 2009-065490

(51) Int. Cl. C01B 3/04; B01J 20/04

(52) U.S. Cl. 423/658.2; 502/400

(57) ABSTRACT

The present invention is: a hydride composite containing NaH and a metal salt containing an alkali earth metal or a transition metal; and a preparation process of a hydrogen gas including a reaction process to react such a hydride composite with an ammonia gas. Further, the present invention is: a hydride composite containing NaH, a metal salt containing an alkali earth metal or a transition metal, and an ammonia source that is a solid at ordinary temperatures and generates an ammonia gas by decomposition; and a preparation process of a hydrogen gas including a reaction process to heat such a hydride composite.

### FIELD OF THE INVENTION

The present invention relates to a hydride composite capable of storing and releasing hydrogen in a reversible manner and a preparation process of a hydrogen gas.

### BACKGROUND OF THE INVENTION

Hydrogen energy has recently been drawing attention as a clean alternative energy in view of environmental problems such as global warming due to emission of a carbon dioxide gas or energy problems such as depletion of petroleum resources. For industrialization of the hydrogen energy, it is important to develop technologies for storing and transporting hydrogen with safety. There are some candidates for the storage method of hydrogen. Among them, a method of using hydride/hydrogen storage materials capable of storing and releasing hydrogen in a reversible manner are considered as the safest means for storing/transporting hydrogen. It is expected as a hydrogen storage medium to be installed on fuel cell cars.

As the hydrogen storage material, carbon materials such as activated carbon, fullerene, and nanotube, and hydrogen storage alloys such as LaNi₅ and TiFe are known. Of these, hydrogen storage alloys are promising as hydrogen storage materials for storing/transporting hydrogen because of a high hydrogen density per unit volume compared with carbon materials.

Since the hydrogen storage alloys such as LaNi₅, TiFe, and others contain metals such as La, Ni, Ti, and others, however, there lie problems that the resources are hardly secured and the cost is high.

Further, although there are materials to store hydrogen easily from the beginning like rare-earth alloys such as LaNi₅, a hydrogen storage alloy generally has a low hydrogen storage capacity because of a gas absorbed on an alloy surface and an oxide film. Consequently, pretreatment (initial activation) is required of such an alloy in order to expose a clean alloy surface. TiFe in particular is hardly subjected to initial activation and requires treatment (activation treatment) of repeating the storage of hydrogen and the release of the stored hydrogen several times under a high temperature and a high pressure in order to store and release a relatively large amount of hydrogen.

Moreover, since a conventional hydrogen storage alloy itself has a heavy weight, the hydrogen density per unit weight is low. That is, the problem here is that a very heavy storage material is required in order to store a large amount of hydrogen.

In order to solve the problems, it is attempted to develop complex hydride including light elements as a hydrogen storage material that can release hydrogen. The heretofore developed and known hydride/hydrogen storage materials containing light elements are as follows:

(1) complex hydride/hydrogen storage materials containing lithium (Li) such as LiNH₂, LiBH₄, and the like (refer to Patent document 1 and Non-patent document 1, for example);
(2) complex hydride/hydrogen storage materials containing sodium (Na) such as NaAlH₄ and the like; and
(3) complex hydride/hydrogen storage materials containing magnesium (Mg) such as Mg(NH₂)₂ and the like.

Further, Patent document 2 discloses:

(1) a method for obtaining hydrogen by reacting LiH with NH₃; and
(2) a method for obtaining hydrogen by reacting LiH+0.05TiCl₃ (49.24 mol % equivalent) with NH₃.

Patent document 2 describes:

(a) that the hydrogen yield increases by applying milling treatment for 2 hours in a planetary ball mill before reaction with NH₃; and
(b) that the hydrogen yield increases by adding TiCl₃.

Furthermore, Patent document 3 discloses:

(1) a first method for obtaining hydrogen by applying milling treatment to Mg(NH₃)₆Cl₂+12LiH for 2 hours in a planetary ball mill and heating the ground mixture, and
(2) a second method for obtaining hydrogen by applying milling treatment to MgCl₂+12LiH+0.01LiNH₂+0.01TiCl₃ for 2 hours, reacting the ground mixture with NH₃ of an amount sufficient for the ammine complexation of MgCl₂, and heating the reacted material.

Patent document 3 describes:

(a) that hydrogen of a high purity can be obtained by such a method; and
(b) that, in the second method of realizing the ammine complexation by reacting MgCl₂ with NH₃, the amount of NH₃ is larger than that of NH₃ released by the first method of adding Mg (NH₃)₆Cl₂.

[Patent document 1] Japanese translation of PCT International Application No. 2002-526658

[Patent document 2] Japanese Patent Application Laid-Open No. 2005-154232

[Patent document 3] Japanese Patent Application Laid-Open No. 2008-018420

[Non-patent document 1] P. Chen and four others, “Interaction of hydrogen with metal nitrides and imides”, Nature, 2002, vol. 420/21, p. 302-304

A hydride/hydrogen storage material containing light elements makes it relatively easy to secure resources, and shows a relatively low cost. The drawback, however, is that a hydride/hydrogen storage material containing light elements generally has a high hydrogen release temperature.

For example, the reaction between LiH and NH₃ starts at a relatively low temperature (comparable to a room temperature). The reaction stops soon however and hence pure hydrogen is hardly obtained. The reason is presumably that LiH is solid particles and reaction starts from the particle surface. That is, since the surface of LiH particle is covered with LiNH₂ as the reaction product after the early stage of the reaction, excessive energy is required in order that ammonia may permeate a LiNH₂ layer and reach unreacted LiH in the interior of the particles. Consequently, a high temperature of 200° C. to 300° C. is required in order to progress the reaction.

Meanwhile, long time grinding in a ball mill or additive added grinding in a ball mill is also applied in order to enhance the activity of LiH. Excessive time and energy are required, however, for the grinding in a ball mill. Further, there are many cases where the effect of an additive lacks in repeatability. Moreover, the long time ball milling is required again in order to release hydrogen again from regenerated LiH.

Further, in a method of mixing Mg (NH₃)₆Cl₂ with LiH, hydrogen may be generated when ball milling is applied. Furthermore, ball milling does not necessarily lower the hydrogen generation temperature of a material. Moreover, it is difficult to regenerate the original material from a decomposition product (ideally mixture of LiNH₂ and MgCl₂) after hydrogen generation.

The reasons why the regeneration of the original material from a decomposition product is difficult are presumably because:

(1) although a high temperature is required in order to regenerate LiH from LiNH₂ under hydrogen atmosphere, MgCl₂ does not absorb ammonia at a high temperature; and
(2) if ammonia is reapplied to the regenerated material after LiH is regenerated while evacuating ammonia, the ammonia gas reacts with not only MgCl₂ but also LiH.

### SUMMARY OF THE INVENTION

A problem to be solved by the present invention is to provide: a hydride composite that can generate a hydrogen gas of a relatively high purity at a low temperature of 200° C. or lower and is easily regenerated; and a preparation process of the hydrogen gas by using such a hydride composite.

In order to solve the above problem, a first hydride composite according to the present invention contains NaH and a metal salt containing an alkali earth metal or a transition metal.

A second hydride composite according to the present invention contains NaH, a metal salt containing an alkali earth metal or a transition metal, and an ammonia source that is a solid at ordinary temperatures and generates an ammonia gas by decomposition.

In this case, it is preferable that the metal salt can form ammine complexes and is MgCl₂ in particular.

A first preparation process of a hydrogen gas according to the present invention includes a reaction process to react the first hydride composite according to the present invention with an ammonia gas.

Further, a second preparation process of a hydrogen gas according to the present invention includes a reaction process to heat the second hydride composite according to the present invention.

It is possible to generate a hydrogen gas of a relatively high purity at a low temperature of 200° C. or lower by adding a metal salt (MgCl₂ in particular) to NaH and reacting the mixture with an ammonia gas. This is presumably because a metal salt forms a relatively unstable unsaturated ammine complex and the unsaturated amine complex functions as an ammonia conductor in a solid. Moreover, the material after hydrogen gas is released can easily be regenerated into the original material.

Further, hydrogen starts to be generated from a temperature of 100° C. or lower by further adding an ammonia source to the mixture of NaH and a metal salt (MgCl₂ in particular).

### BRIEF DESCRIPTION OF THE DRAWINGS

FIG. 1 is a general configuration diagram of a test apparatus;

FIG. 2 shows the result of TPD-MS (temperature programmed desorption-mass spectrometry) of a gas released by the decomposition of Ni(NH₃)₆Cl₂ used as an ammonia source;

FIG. 3 shows the result of TPD-MS (temperature programmed desorption-mass spectrometry) of a gas released after a specimen prepared by grinding commercially available LiH for 12 hours reacts with NH₃ derived from Ni(NH₃)₆Cl₂;

FIG. 4 shows the result of TPD-MS (temperature programmed desorption-mass spectrometry) of a gas released after a specimen prepared by co-grinding commercially available LiH+10 mass % TiCl₃ for 12 hours reacts with NH₃ derived from Ni (NH₃)₆Cl₂;

FIG. 5 shows the result of TPD-MS (temperature programmed desorption-mass spectrometry) of a gas released after a specimen prepared by grinding commercially available NaH for 12 hours reacts with NH₃ derived from Ni(NH₃)₆Cl₂;

FIG. 6 shows the result of TPD-MS (temperature programmed desorption-mass spectrometry) of a gas released after a specimen prepared by mixing commercially available NaH ground for 12 hours and 10 mass % MgCl₂ in a mortar reacts with NH₃ derived from Ni(NH₃)₆Cl₂;

FIG. 7 shows the result of TPD-MS (temperature programmed desorption-mass spectrometry) of a gas released after a specimen prepared by co-grinding commercially available NaH+10 mass % MgCl₂ for 1 minute reacts with NH₃ derived from Ni(NH₃)₆Cl₂;

FIG. 8 shows the result of TPD-MS (temperature programmed desorption-mass spectrometry) of a gas released after a specimen prepared by co-grinding commercially available NaH+10 mass % MgCl₂ for 10 minutes reacts with NH₃ derived from Ni(NH₃)₆Cl₂;

FIG. 9 shows the result of TPD-MS (temperature programmed desorption-mass spectrometry) of a gas released after a specimen prepared by co-grinding commercially available NaH+10 mass % MgCl₂ for 2 hours reacts with NH₃ derived from Ni(NH₃)₆Cl₂;

FIG. 10 shows the result of TPD-MS (temperature programmed desorption-mass spectrometry) of a gas released after a specimen prepared by co-grinding commercially available NaH+10 mass % MgCl₂ for 24 hours reacts with NH₃ derived from Ni(NH₃)₆Cl₂;

FIG. 11 shows the result of TPD-MS (temperature programmed desorption-mass spectrometry) of a gas released after a specimen prepared by co-grinding commercially available NaH+1 mass % MgCl₂ for 2 hours reacts with NH₃ derived from Ni(NH₃)₆Cl₂;

FIG. 12 shows the result of TPD-MS (temperature programmed desorption-mass spectrometry) of a gas released after a specimen prepared by co-grinding commercially available NaH+5 mass % MgCl₂ for 2 hours reacts with NH₃ derived from Ni(NH₃)₆Cl₂;

FIG. 13 shows the result of TPD-MS (temperature programmed desorption-mass spectrometry) of a gas released after a specimen prepared by co-grinding commercially available NaH+20 mass % MgCl₂ for 2 hours reacts with NH₃ derived from Ni(NH₃)₆Cl₂;

FIG. 14 shows the result of TPD-MS (temperature programmed desorption-mass spectrometry) of a gas released after a specimen prepared by co-grinding commercially available NaH+10 mass % FeCl₂ for 2 hours reacts with NH₃ derived from Ni(NH₃) ₆Cl₂;

FIG. 15 shows the result of TPD-MS (temperature programmed desorption-mass spectrometry) of a gas released after a specimen prepared by co-grinding commercially available NaH+10 mass % TiCl₃ for 2 hours reacts with NH₃ derived from Ni(NH₃)₆Cl₂;

FIG. 16 is a graph showing the relationship between the grinding time of a NaH—MgCl₂ type hydride composite and the signal intensity ratio of hydrogen to ammonia;

FIG. 17 is a graph showing the relationship between the amount of MgCl₂ added to a NaH—MgCl₂ type hydride composite and the signal intensity ratio of hydrogen to ammonia;

FIG. 18 is a graph showing the signal intensity ratios of hydrogen to an ammonia gas in various kinds of hydride composites;

FIG. 19 shows the result of TPD-MS (temperature programmed desorption-mass spectrometry) of a gas released from a specimen prepared by co-grinding for 2 hours the mixture of NaH ground for 12 hours and Mg(NH₂)₂ mixed in the molar ratio of two to one; and

FIG. 20 shows the result of TPD-MS (temperature programmed desorption-mass spectrometry) of a gas released from a specimen prepared by co-grinding commercially available NaH+10 mass % MgCl₂ for 2 hours, thereafter adding Mg(NH₂)₂ so that the expression NaH:Mg(NH₂)₂=4:1 may be satisfied, and further co-grinding the mixture for 2 hours.

### DETAILED DESCRIPTION OF THE PREFERRED EMBODIMENTS

Embodiments according to the present invention are hereunder explained in detail.

### [1. Hydride Composite (1)]

A hydride composite according to the first embodiment of the present invention contains NaH and a metal salt.

Here, in the present invention, a “hydride composite” means a substance capable of releasing a hydrogen gas.

In the present invention, a “hydrogen storage material” means a substance capable of storing a hydrogen gas. The “hydrogen storage material” includes not only a material from which hydrogen is completely released but also a material that stores hydrogen of an amount not reaching the maximum storage capacity.

### [1.1 NaH]

A hydride composite according to the present embodiment contains NaH as the hydride. The expression (1) shows the reaction formula of NH₃ and NaH containing a metal salt (referred to as “NaH*”). In the present embodiment, NH₃ is supplied from outside the hydride composite.

NH₃+NaH*→NaNH₂+H₂ (1)

Generally metal hydride generates hydrogen when it reacts with NH₃. In general, the hydrogen yield at a low temperature of 200° C. or lower is smaller when NaH reacts with NH₃ than when another hydride (LiH for example) reacts with NH₃. When a certain kind of metal salt coexists, however, the hydrogen yield of NaH at a low temperature is larger than that of another metal hydride such as LiH.

### [1.2 Metal Salt]

A metal salt contains an alkali earth metal or a transition metal. A metal salt has the function as a catalyst to accelerate the reaction between NaH and NH₃.

Examples of metal salts having such a function include compounds represented by the general expression MXₙ (M=Mg, Ca, Sc, Ti, V, Cr, Mn, Fe, Co, Ni, Cu, Zn; X=F, Cl, Br, I; and n=an oxidation number of metal M).

Concrete examples of the compounds are:

(1) chlorides such as MgCl₂, NiCl₂, CaCl₂, FeCl₂, CoCl₂, and ZnCl₂;
(2) fluorides such as MgF₂, NiF₂, CaF₂, FeF₂, CoF₂, and ZnF₂; and
(3) bromides such as MgBr₂.

In particular, a metal salt such as MgCl₂, NiCl₂ that can form an ammine complex shows a strong catalytic action to NaH and hence is preferred as a metal salt to be added to NaH.

With regard to the amount of a metal salt addition, an optimum amount is chosen in accordance with the kind of the metal salt. In general, if the amount of a metal salt addition is small, the catalytic action is insufficient. If the amount of a metal salt addition is excessive in contrast, the proportion of the mass of NaH in the total mass of a hydride composite reduces and hence the hydrogen yield reduces.

When MgCl₂ is used as a metal salt, the content of MgCl₂ is preferably in the range of 1 mass % to 20 mass. The content of MgCl₂ is more preferably in the range of 3 mass % to 18 mass %, still more preferably in the range of 4 mass % to 16 mass %, more preferably in the range of 5 mass % to 15 mass %, and still more preferably in the range of 7 mass % to 13 mass.

### [1.3 Grinding Condition]

The reaction between NaH and NH₃ is a reaction between a solid and a gas, and hence the reaction comes to be easier as the grain size of NaH reduces. NaH may be mixed with a metal salt after it is ground to a prescribed grain size beforehand. Otherwise, a mixture of NaH and a metal salt may be co-ground so that NaH may have a prescribed grain size. In particular, a method of co-grinding can produce a homogeneous mixture of NaH and a metal salt and hence is good as a grinding method.

With regard to the grinding condition of NaH or a mixture of NaH and a metal salt, an optimum condition is chosen in accordance with the kind of the metal salt. In general, as the grinding time increases, NaH is more fractionized and hence the hydrogen yield increases. If the grinding time is too long, in contrast, NaH reacts with a metal salt and the like and turns into a substance other than hydride and the hydrogen yield rather decreases.

Among metal salts, MgCl₂ shows a strong catalytic action and hence the hydrogen yield increases only by lightly mixing (mixing in a mortar for example) NaH having a prescribed grain size with MgCl₂. Further, the hydrogen yield further increases by co-grinding the mixture of NaH and MgCl₂.

When the mixture of NaH and MgCl₂ is co-ground, the grinding time is preferably in the range of 2 minutes to 40 hours. The grinding time is more preferably in the range of 3 minutes to 30 hours, still more preferably in the range of 5 minutes to 20 hours, still more preferably in the range of 10 minutes to 15 hours, and still more preferably in the range of 20 minutes to 10 hours.

### [2. Hydride Composite (2)]

A hydride composite according to the second embodiment of the present invention contains NaH, a metal salt, and an ammonia source.

### [2.1 NaH]

The details on NaH are the same as those in the first embodiment and hence the explanations are omitted.

### [2.2 Metal Salt]

The details on a metal salt are the same as those in the first embodiment and hence the explanations are omitted.

### [2.3 Grinding Condition]

The details on the grinding condition are the same as those in the first embodiment and hence the explanations are omitted.

### [2.4 Ammonia Source]

In the present embodiment, an ammonia gas is supplied not from outside a hydride composite but from an ammonia source contained in a hydride composite. This is a point that differentiates the present embodiment from the first embodiment.

An “ammonia source” means a compound that is a solid state at ordinary temperatures and generates an ammonia gas by decomposition. The examples of the ammonia sources are as follows:

(1) ammine complexes (M(NH₃)ₐX_{b}, where M is an alkali earth metal or a transition metal, X is an anion such as halogen, or pseudo halogen, a is a coordination number of M, and b is a valence of M), such as Mg(NH₃)₆Cl₂, Ca(NH₃)₆Cl₂, Ni(NH₃)₆Cl₂, Co(NH₃)₆Cl₃, Ru(NH₃)₆Cl₂, and Ru(NH₃)₆Cl₃;
(2) metal amides (M(NH₂)ₓ, where M is an alkali earth metal or a transition metal and x is a valence of M), such as LiNH₂, Mg(NH₂)₂, NaNH₂, Ca(NH₂)₂, and Eu(NH₂)₂;
(3) ammonium compounds ((NH₄)ₙX, where X is an anion and n is a valence of the anion), such as NH₄Cl, NH₄SCN, (NH₄)₂SO₄, (NH₄)₂CO₃, (NH₄)NO₃, (NH₄)ClO₄, and CH₃COONH₄; and
(4) organic amide compounds such as (NH₂)₂CO and (NH₂)₂CS.

Those materials may be used either individually or as a combination of two or more kinds.

It is preferable that an ammonia source is of the nature that the decomposition product can be regenerated into the ammonia source by reacting the decomposition product after hydrogen release with hydrogen. In the state where NaH or the decomposition product thereof coexists, the examples of ammonia sources that can be regenerated include metal amides, metal nitrides, and metal imides.

The expression (3) shows the reaction formula of Mg(NH₂)₂ as an ammonia source and NaH containing a metal salt (NaH*). Further, the expression (4) shows the reaction formula of LiNH₂ as an ammonia source and NaH containing a metal salt (NaH*). Both the products on the right-hand sides of the expressions (3) and (4) can be regenerated into the compounds on the left-hand sides of the expressions by heating the products under hydrogen pressure.

Mg(NH₂)₂+2NaH*→Na₂Mg(NH)₂+2H₂ (3)

LiNH₂+NaH*→LiNaNH+H₂ (4)

When a metal amide is used as an ammonia source, ideally it is preferable to add the ammonia source by an amount that allows an imide compound to form (a stoichiometric amount) by reacting with NaH. If the amount of the ammonia source addition considerably deviates from the stoichiometric amount, undesirably the ammonia gas yield increases or the hydrogen yield reduces. The same is true in the case where an ammonia source other than a metal amide is used.

When Mg(NH₂)₂ is used as an ammonia source for example, it is preferable to add Mg(NH₂)₂ by 0.1 to 1.0 mole to NaH of 1 mole. A more preferable amount of Mg(NH₂)₂ addition is in the range of 0.2 to 0.5 mole per 1 mole NaH.

In other words, the amount of NaH is preferably in the range of 1 to 10 mole, and more preferably in the range of 2 to 5 mole, per 1 mole Mg(NH₂)₂.

### [3. Preparation Process of Hydrogen Gas (1)]

A preparation process of a hydrogen gas according to the first embodiment of the present invention includes a reaction process to react a hydride composite according to the first embodiment of the present invention with an ammonia gas.

### [3.1 Reaction Process]

### [3.1.1 Ammonia Gas]

In the present embodiment, an ammonia gas is supplied from outside a hydride composite. Methods for supplying an ammonia gas are as follows. Any of the methods may be used in the present embodiment.

### [3.1.1.1 First Method]

The first method for supplying an ammonia gas is a method of introducing an ammonia gas into a container in which a hydride composite is contained. In general, an ammonia gas is introduced into a container together with an appropriate carrier gas. It is preferable to choose the concentration and the flow rate of an ammonia gas in a gas introduced into a container so that the reaction may progress most efficiently.

### [3.1.1.2 Second Method]

The second method for supplying an ammonia gas is a method of generating an ammonia gas by disposing an ammonia source adjacently to a hydride composite and decomposing the ammonia source.

An “ammonia source” means a compound that is in a solid state at ordinary temperatures and generates an ammonia gas by decomposition. The examples of the ammonia sources are as stated above and thus the explanations are omitted.

When the second method is used, the ammonia source may either touch a hydride composite or be disposed at a prescribed distance from a hydride composite.

The expression (2) shows the decomposition reaction formula of an ammonia source. Further, the expression (1) shows the reaction formula of NH₃ and NaH containing a metal salt (NaH*).

Ammonia source→NH₃+decomposition product (2)

NH₃+NaH*→NaNH₂+H₂ (1)

It is preferable that an ammonia source is of the nature that the decomposition product generated in the expression (2) can be regenerated into the ammonia source by reacting the decomposition product with an ammonia gas. That is, in the present embodiment, an ammonia source is in the state of being separated from NaH and hence any ammonia source can be used as long as it can react in the reverse direction of the expression (2).

Further, it is preferable to use an ammonia source that has a large hydrogen yield (the rate of the weight of a hydrogen gas to the total weight of an ammonia source and a hydride composite).

For example, Mg(NH₃)₆Cl₂ is regeneratable, has a hydrogen yield of 3.5 mass %, and hence is preferable as an ammonia source.

Likewise, (NH₂)₂CO is regeneratable, has a hydrogen yield of 2.4 mass %, and hence is preferable as an ammonia source.

Likewise, NH₄Cl is regeneratable, has a hydrogen yield of 2.6 mass %, and hence is preferable as an ammonia source.

### [3.1.2 Reaction Condition]

A hydride composite reacts with NH₃ by heating the hydride composite to a prescribed temperature under the condition that NH₃ coexists. When only NaH is heated, hydrogen release occurs around 375° C. When only NaH (ground for 12 hr) and NH₃ from Ni(NH₃)₆Cl₂ reacts, the release peak of hydrogen appears at three temperatures of about 125° C., about 225° C., and about 350° C. By adding a prescribed metal salt to NaH, it is possible to generate a larger amount of hydrogen at a lower temperature.

### [3.2 Regeneration Process]

NaH containing a metal salt (NaH*) can be regenerated by reacting a reaction product (NaNH₂) with hydrogen after hydrogen is released in accordance with the expression (1).

Further, when an ammonia gas is generated by using a regeneratable ammonia source, the ammonia source can be regenerated by reacting the decomposition product of the expression (2) with NH₃.

### [4. Preparation Process of Hydrogen Gas (2)]

A preparation process of a hydrogen gas according to the second embodiment of the present invention includes a reaction process to heat a hydride composite according to the second embodiment of the present invention.

### [4.1 Reaction Process]

In the present embodiment, a hydride composite contains an ammonia source. Consequently, an ammonia gas is generated from the ammonia source only by heating the hydride composite. Further, the generated ammonia gas reacts with the hydride composite, and hydrogen of an amount corresponding to the heating temperature is generated.

Examples of the reaction formulae are shown in the expressions (3) and (4).

Mg(NH₂)₂+2NaH*→Na₂Mg(NH)₂+2H₂ (3)

LiNH₂+NaH*→LiNaNH+H₂ (4)

### [4.2 Regeneration Process]

When it is used an ammonia source that can be regenerated even under the condition that NaH or the decomposition product thereof coexists, the hydride composite can be regenerated by reacting the decomposition product after hydrogen release with hydrogen. For example, both the products on the right-hand sides of the expressions (3) and (4) can be regenerated into the compounds on the left-hand sides of the expressions by heating the products under hydrogen pressure.

### [5. Effects of Hydride Composite and Preparation Process of Hydrogen Gas]

Hydrogen is generated by reacting a metal hydride such as LiH or NaH with NH₃. In order to steadily generate hydrogen from LiH, however, it is necessary to heat it to a high temperature. This is because the surface of LiH is covered with LiNH₂ as the reaction product and excessive energy is required in order that ammonia may permeate the LiNH₂ layer.

The reactivity of NaH with NH₃ is lower than that of LiH. Consequently, if NaH reacts with NH₃, a relatively large amount of NH₃ remains in the generated gas.

Further, when NaH reacts with NH₃, it is also possible to use a solid ammonia source. The following expression (5) shows the reaction formula of Mg(NH₂)₂ as an ammonia source and NaH.

Mg(NH₂)₂+2NaH→Na₂Mg(NH)₂+2H₂ (5)

When the reaction progresses in accordance with the expression (5), the hydrogen yield is 3.9 mass %. Since NaH has a low reactivity with NH₃, however, an unreacted ammonia gas is likely to be released outside the system. When an unreacted ammonia gas is released outside the system, the hydride and the metal amide are not regenerated even though the decomposition product is heated under hydrogen pressure.

In contrast, when a metal salt (in particular, a metal salt that can form an ammine complex such as MgCl₂, NiCl₂, and the like) is added to NaH and reacts with an ammonia gas, a hydrogen gas of a relatively high purity can be generated at a low temperature of 200° C. or lower. The details of the reaction mechanism are not known but are estimated as follows.

That is, the added metal salt (in particular, MgCl₂, NiCl₂, and the like) is likely to coordinate with ammonia. Consequently, the metal salt forms a stable ammine complex (M(NH₃)₆Cl₂ and the like, for example) under the circumstance of a high ammonia partial pressure. When the ammonia partial pressure is low in contrast, the metal salt forms a relatively unstable unsaturated ammine complex UM(NH₃)Cl₂ and the like, for example). The unsaturated ammine complex is low in stability, is likely to receive ammonia, and hence functions as an ammonia conductor in a solid. As a result, the diffusion of ammonia into the solid is accelerated by the addition of the metal salt and a larger amount of hydrogen is generated at a lower temperature.

Further, when a decomposition product after hydrogen release reacts with hydrogen, NaNH₂ contained in the decomposition product is regenerated into NaH. Furthermore, when a decomposition product is heated to a high temperature, ammonia is released from an ammine complex or an unsaturated ammine complex contained in the decomposition product and MgCl₂ is regenerated.

Further, when an ammonia source is further added to the mixture of NaH and a metal salt (in particular, MgCl₂, NiCl₂, and the like), hydrogen start to be generated from a temperature of 100° C. or lower.

In particular, when Mg(NH₂)₂ is used as an ammonia source, the reaction between NaH and NH₃ is accelerated and the amount of a NH₃ gas decreases to an amount smaller than the detection limit. Further, since the amount of a NH₃ gas released outside the system is very small, the mixture of NaH, a metal salt, and an ammonia source is regenerated by heating the decomposition product of the system under hydrogen pressure.

### Examples

### Examples 1 to 10, Comparative Examples 1 to 3, and Reference Example 1

[1. Test method]

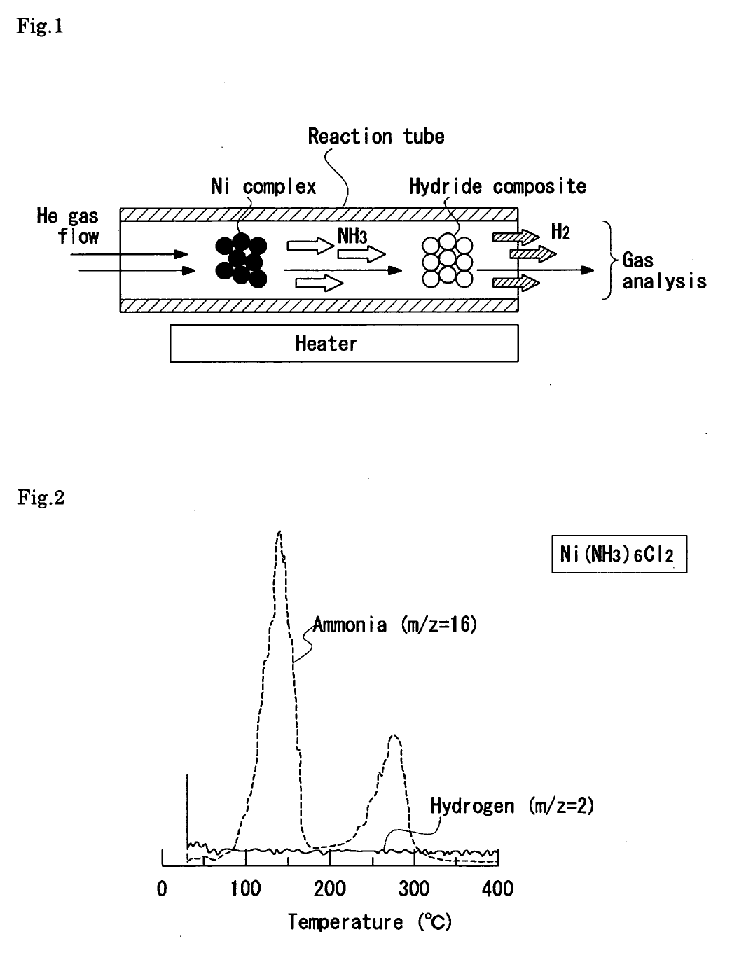

A test apparatus shown in FIG. 1 is prepared in order to investigate the efficiency of hydrogen generation caused by the reaction between ammonia and a hydride composite. The test apparatus has a reaction tube and a heater that can heat the reaction tube. A He source (not shown in the figure) is disposed at the upstream end of the reaction tube so that He as a carrier gas for analysis may be introduced into the reaction tube. A gas analyzer (not shown in the figure) is disposed at the downstream end of the reaction tube so that the gas released from the reaction tube may be subjected to mass spectrometric analysis. A Ni complex (Ni(NH₃)₆Cl₂) as the ammonia source is placed on the upstream side of the reaction tube. A hydride composite is placed on the downstream side of the reaction tube.

When the reaction tube is heated to a prescribed temperature in such a state, ammonia is released from the Ni complex. The released ammonia reacts with the hydride composite at the temperature when it passes through the hydride composite layer and hydrogen is generated. The gas after the reaction is observed with a mass spectrometer.

The gasses that are subjected to temperature programmed desorption-mass spectrometry (TPD-MS) are as follows:

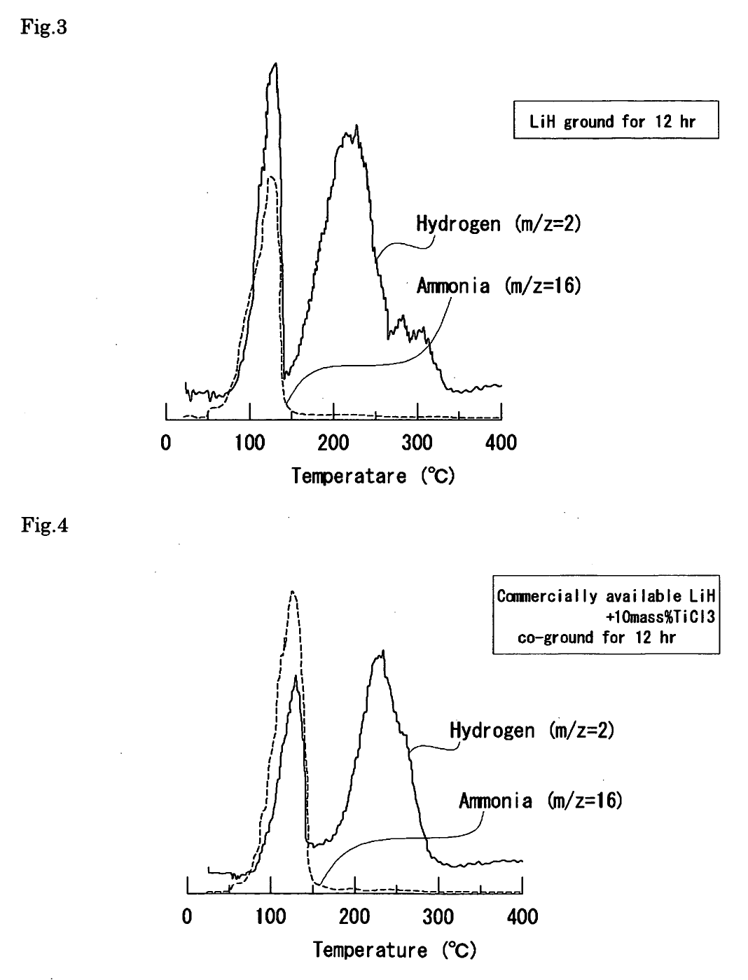

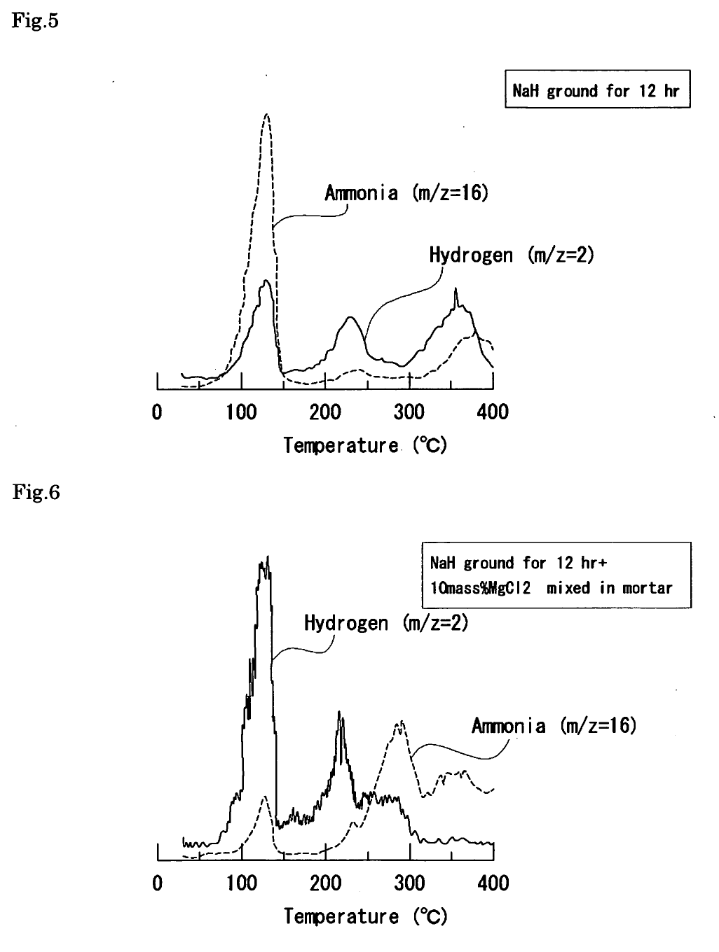

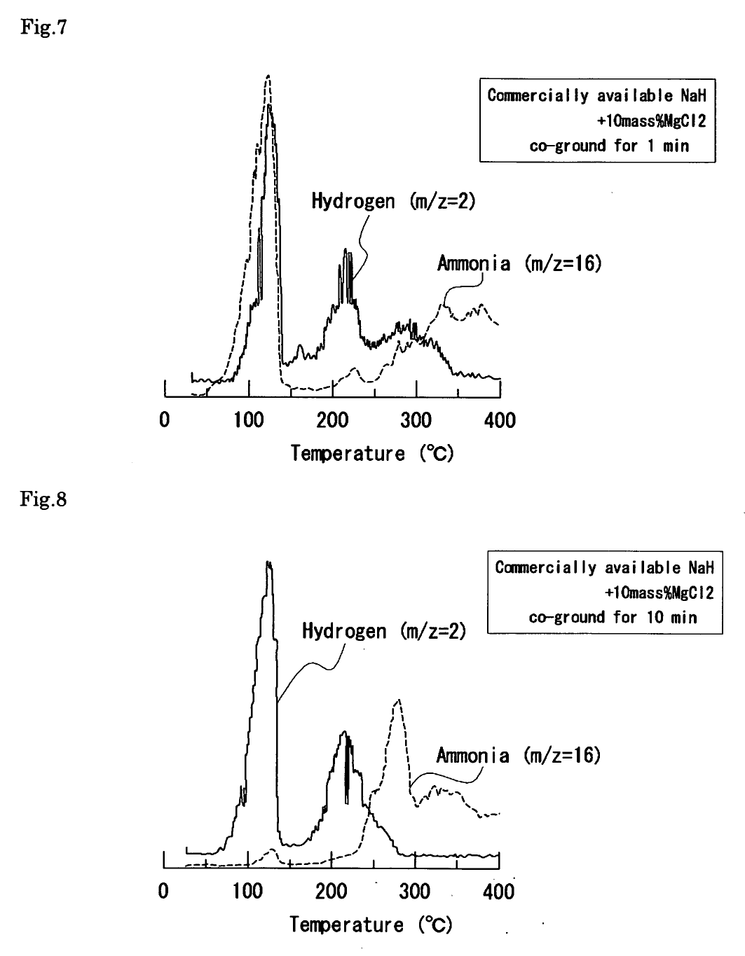

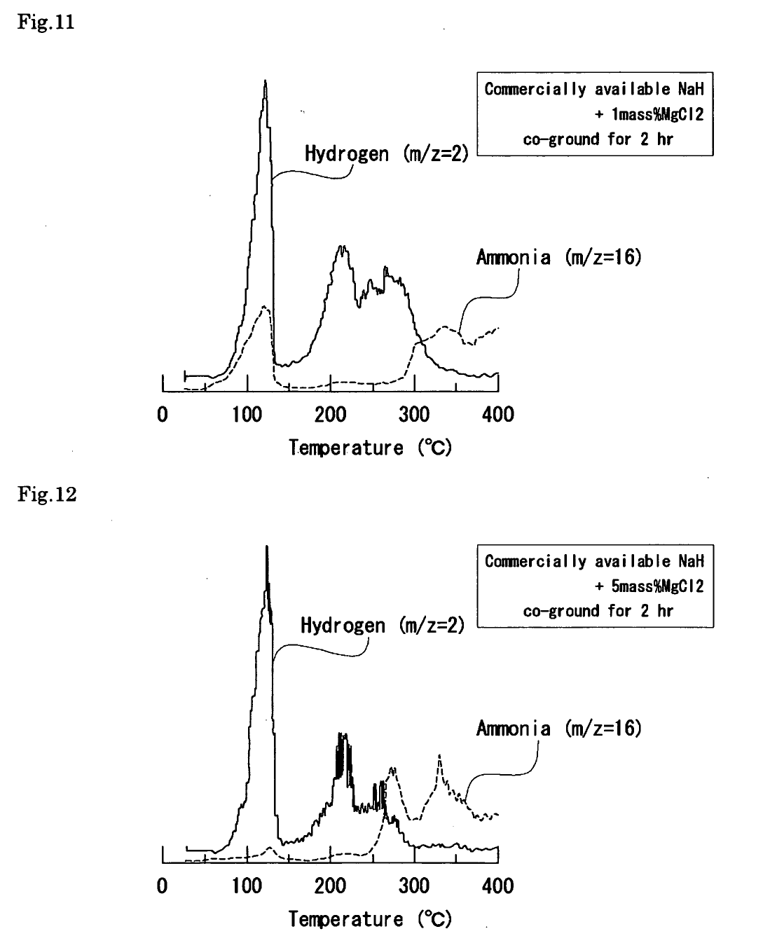

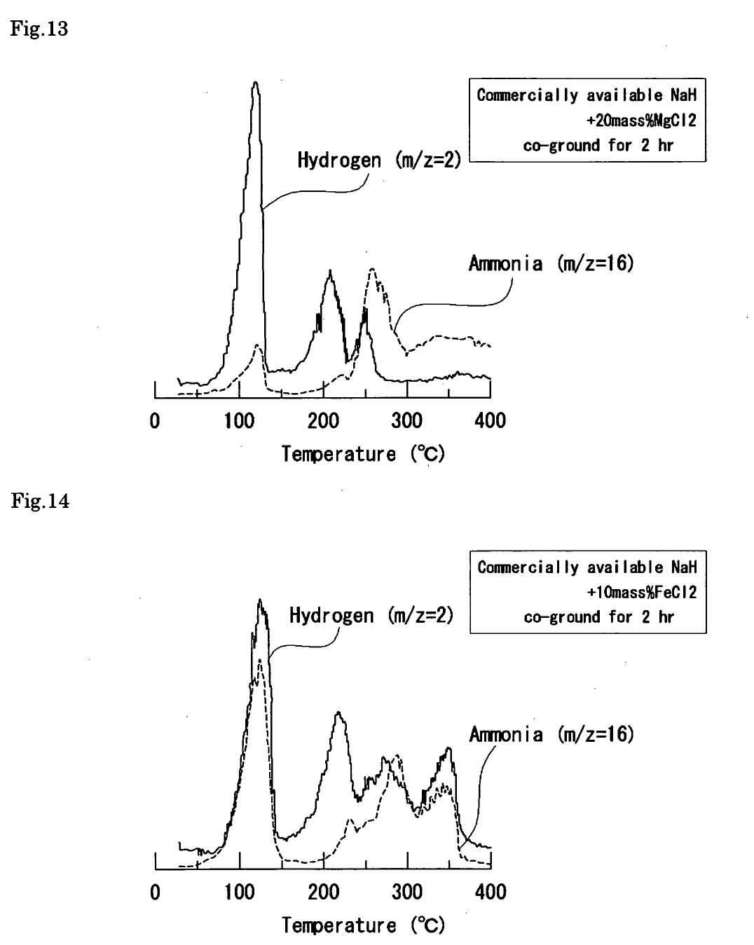

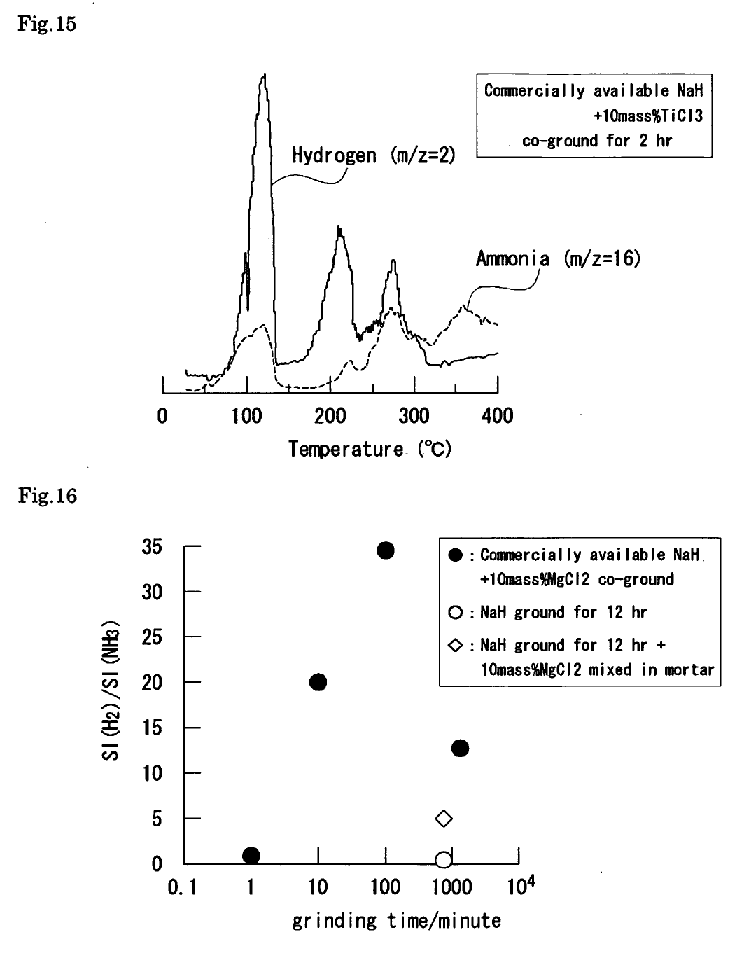

(1) A gas released from a Ni complex (Ni(NH₃)₆Cl₂) used as an ammonia source (Reference example 1, FIG. 2);
(2) A gas released after a specimen prepared by grinding commercially available LiH for 12 hours reacts with NH₃ derived from a Ni complex (Comparative example 1, FIG. 3);
(3) A gas released after a specimen prepared by co-grinding commercially available LiH+10 mass % TiCl₃ for 12 hours reacts with NH₃ derived from a Ni complex (Comparative Example 2, FIG. 4);
(4) A gas released after a specimen prepared by grinding commercially available NaH for 12 hours reacts with NH₃ derived from a Ni complex (Comparative example 3, FIG. 5);
(5) A gas released after a specimen prepared by mixing NaH ground for 12 hours and 10 mass % MgCl₂ in a mortar reacts with NH₃ derived from a Ni complex (Example 1, FIG. 6);
(6) A gas released after a specimen prepared by co-grinding commercially available NaH+10 mass % MgCl₂ for 1 minute to 24 hours reacts with NH₃ derived from a Ni complex (Examples 2 to 5, FIGS. 7 to 10);
(7) A gas released after a specimen prepared by co-grinding commercially available NaH+1 to 20 mass % MgCl₂ for 2 hours reacts with NH₃ derived from a Ni complex (Examples 6 to 8, FIGS. 11 to 13);
(8) A gas released after a specimen prepared by co-grinding commercially available NaH+10 mass % FeCl₂ for 2 hours reacts with NH₃ derived from a Ni complex (Example 9, FIG. 14); and
(9) A gas released after a specimen prepared by co-grinding commercially available NaH+10 mass % TiCl₃ for 2 hours reacts with NH₃ derived from a Ni complex (Example 10, FIG. 15).

A ball mill is used for grinding. When the ball mill grinding is applied, balls and a specimen are put into a container so that the mass ratio may be 100:1 in an argon atmosphere. The grinding is applied for a prescribed time at a revolution speed of 190 rpm.

### [2. Results]

### [2.1 TPD-MS of Ni Complex (Reference Example 1)]

The result of the TPD-MS of a Ni complex used as the ammonia source is shown in FIG. 2. From FIG. 2, it is obvious that the Ni complex releases ammonia at two temperature ranges of about 100° C. to 170° C. and about 250° C. to 300° C. Consequently, it is possible to know the reactivity of the hydride composite in each temperature region.

Ideally, the whole released ammonia is converted into hydrogen and hence hydrogen is released at the pattern of the ammonia shown in FIG. 2.

[2.2 TPD-MS of LiH (Comparative Example 1), LiH+10 mass % TiCl₃ (Comparative Example 2), and NaH (Comparative Example 3)

The results of the TPD-MS of LiH (ground for 12 hours), LiH+10 mass % TiCl₃ (co-ground for 12 hours), and NaH (ground for 12 hours) are shown in FIGS. 3 to 5, respectively.

When LiH (FIG. 3) and LiH+10 mass % TiCl₃ (FIG. 4) are compared with each other, it is obvious that the hydrogen yield in both the cases are nearly identical to each other. That is, the catalytic effect of TiCl₃ on LiH is very small. In a high temperature environment of 150° C. or higher, ammonia is quantitatively converted into hydrogen regardless of the existence of TiCl₃. Meanwhile, a large amount of ammonia is observed at about 100° C. and moreover the ammonia yield is larger in the case where TiCl₃ is added. This is because the proportion of LiH in the specimen decreases due to the addition of TiCl₃.

When no additive is added, the hydrogen yield of NaH (FIG. 5) is smaller than that of LiH.

### [2.3 TPD-MS of NaH+10 Mass % MgCl₂ (Examples 1 to 5)]

The result of the TPD-MS of a specimen prepared by adding 10 mass % MgCl₂ to NaH ground for 12 hours and mixing them in a mortar is shown in FIG. 6. From FIG. 6, it is obvious that the hydrogen yield compared to the ammonia yield increases largely. When sufficiently ground NaH and MgCl₂ are mixed, even a simple mixture in a mortar can exhibit an effect.

The results of the TPD-MS of specimens prepared by co-grinding the mixture of non-pretreated commercially available NaH and 10 mass % MgCl₂ for various hours are shown in FIGS. 7 to 10.

Even though the grinding time is 1 minute, the effect of adding MgCl₂ appears. By comparing FIG. 5 with FIG. 7, it is understood that the case of adding MgCl₂ to NaH and co-grinding for 1 minute is more effective than the case of grinding NaH for 12 hours. Further, compared to LiH, it is not necessary to repeat the grinding of about 12 hours after regeneration and it is expected that it comes to be a hydrogen generating method of high energy efficiency.

By the grinding treatment of 10 minutes, the amount of the residual ammonia reduces drastically at a low temperature. Further, even by the grinding treatment of 2 hours, the amount of the residual ammonia is very small at a low temperature. By the grinding treatment of 24 hours, however, the ammonia yield rather increases. It is estimated that the reason why the improvement of performance is not seen even when the grinding time is prolonged more than necessary is that NaCl is generated by the long-time grinding and the amount of NaH as the hydrogen generation source reduces.

### [2.4 TPD-MS of NaH+1 to 20 Mass % MgCl₂ (Examples 6 to 8)]

The results of the TPD-MS of specimens prepared by co-grinding a mixture of non-pretreated commercially available NaH and 1 to 20 mass % MgCl₂ for 2 hours are shown in FIGS. 11 to 13.

When MgCl₂ is added to NaH, the effect appears even though the amount of MgCl₂ addition is 1 mass %. The effect of the addition is significant in the case of the addition of 5 mass % and the ammonia yield is small at a low temperature. In contrast, when the amount of MgCl₂ addition is 20 mass %, ammonia is generated remarkably. This is because MgCl₂ is added excessively and hence the mass ratio of NaH in the specimen reduces.

### [2.5 TPD-MS of NaH+10 Mass % FeCl₂ (Example 9) and NaH+10 Mass % TiCl₃ (Example 10)]

The result of the TPD-MS of a specimen prepared by co-grinding the mixture of non-pretreated commercially available NaH and 10 mass % FeCl₂ for 2 hours is shown in FIG. 14. Further, the result of TPD-MS of a specimen prepared by co-grinding the mixture of non-pretreated commercially available NaH and 10 mass % TiCl₃ for 2 hours is shown in FIG. 15.

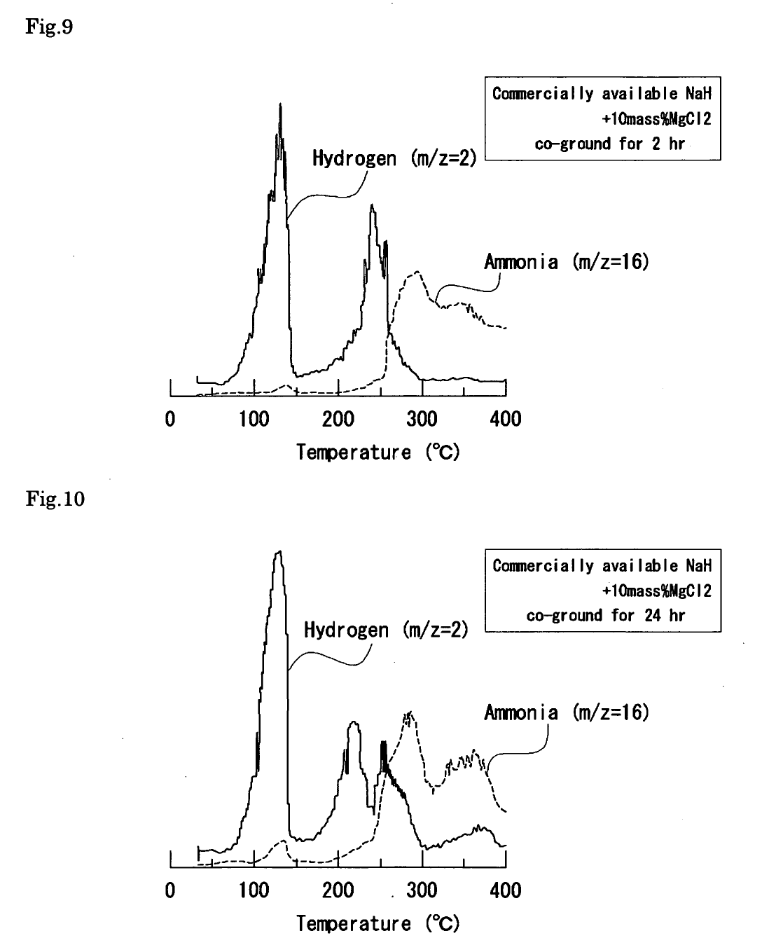

From FIGS. 14 and 15, it is obvious that, although the effect of the addition is seen to some extent in the cases of FeCl₂ and TiCl₃, the amount of the residual ammonia is large in comparison with the case of 10 mass MgCl₂ addition+2-hour co-grinding (FIG. 9).

### [2.6 Influence of Added MgCl₂ Amount and Grinding Time]

The relationship between the grinding time of NaH+10 mass % MgCl₂ and the signal intensity ratio is shown in FIG. 16. Here, a “signal intensity ratio” means the ratio (=SI(H₂)/SI(NH₃)) of the height of the peak signal of hydrogen (the height from the base line to the apex) SI(H₂) to the height of the peak signal of ammonia (the height from the base line to the apex) SI(NH₃) at about 125° C. The larger the ratio, the more efficiently the ammonia released from a Ni complex is converted into hydrogen.

Here, the results of NaH ground for 12 hours (Comparative example 3) and the specimen prepared by mixing the mixture of NaH ground for 12 hours and 10 mass % MgCl₂ in a mortar (Example 1) are additionally shown in FIG. 16.

From FIG. 16, it is obvious:

(1) that it is preferable to control the grinding time in the range of 2 minutes to 40 hours in order to obtain a large signal intensity ratio comparable to or more than that of the mortar mixture (Example 1);
(2) that it is preferable to control the grinding time in the range of 3 minutes to 30 hours in order to obtain a signal intensity ratio of 10 or more;
(3) that it is preferable to control the grinding time in the range of 5 minutes to 20 hours in order to obtain a signal intensity ratio of 15 or more;
(4) that it is preferable to control the grinding time in the range of 10 minutes to 15 hours in order to obtain a signal intensity ratio of 20 or more; and
(5) that it is preferable to control the grinding time in the range of 20 minutes to 10 hours in order to obtain a signal intensity ratio of 25 or more.

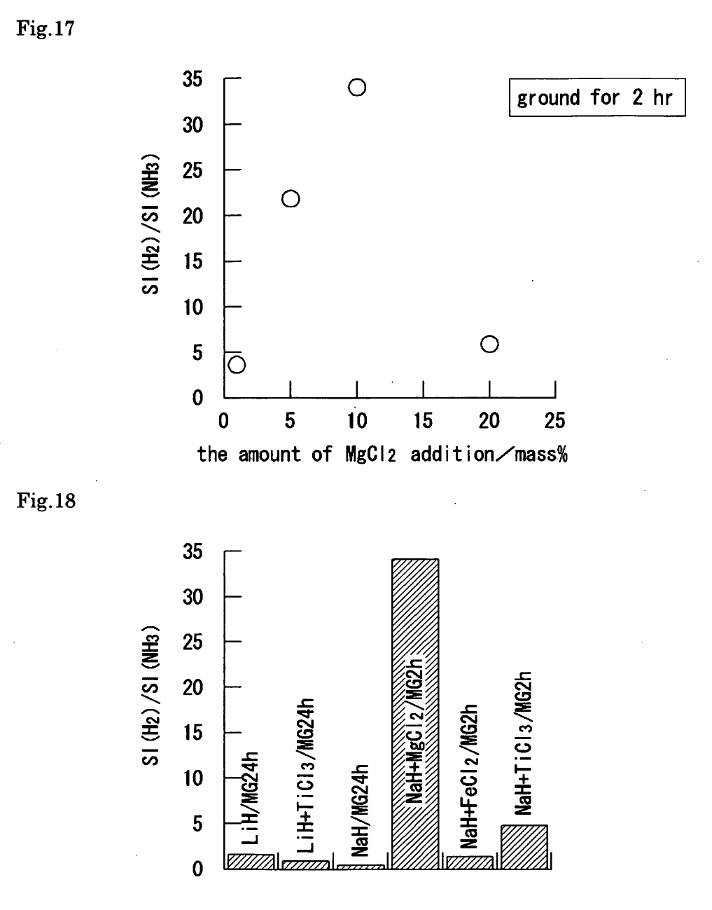

The relationship between the amount of MgCl₂ addition to a NaH—MgCl₂ specimen co-ground for 2 hours and the signal intensity ratio is shown in FIG. 17.

From FIG. 17, it is obvious:

(1) that it is preferable to control the amount of MgCl₂ addition in the range of 1 mass % to 20 mass % in order to obtain a larger signal intensity ratio comparable to or more than that of the specimen of LiH+10 mass % TiCl₃ co-ground for 12 hours (Comparative example 2);
(2) that it is preferable to control the amount of MgCl₂ addition in the range of 3 mass % to 18 mass % in order to obtain a signal intensity ratio of 10 or more;
(3) that it is preferable to control the amount of MgCl₂ addition in the range of 4 mass % to 16 mass % in order to obtain a signal intensity ratio of 15 or more;
(4) that it is preferable to control the amount of MgCl₂ addition in the range of 5 mass % to 15 mass % in order to obtain a signal intensity ratio of 20 or more; and
(5) that it is preferable to control the amount of MgCl₂ addition in the range of 7 mass % to 13 mass % in order to obtain a signal intensity ratio of 25 or more.

The signal intensity ratios of various specimens are shown in FIG. 18.

From FIG. 18, it is obvious:

(1) that a signal intensity ratio increases by adding a metal salt to NaH; and
(2) that a signal intensity ratio increases remarkably by adding MgCl₂ to NaH in comparison with the case of adding another metal salt.

### Example 11, Comparative Example 4

### [1. Preparation of Specimen]

Mg(NH₂)₂ and a hydride are weighed so that the molar ratio may be 1:4 (Example 11) or 1:2 (Comparative example 4) and are co-ground for 2 hours under a hydrogen atmosphere of 9 atmospheric pressure in a ball mill. The mass ratio of balls to a specimen is 100:1 and the revolution speed is 190 rpm. As the hydride, NaH ground for 12 hours (Comparative example 4) or NaH+10 mass % MgCl₂ co-ground for 2 hours (Example 11) is used.

### [2. Test Method]

The same method as in Examples 1 to 10 is used except that a Ni complex is not put into the reaction tube and the gas released from each of the specimens is subjected to mass spectrometric analysis.

### [3. Results]

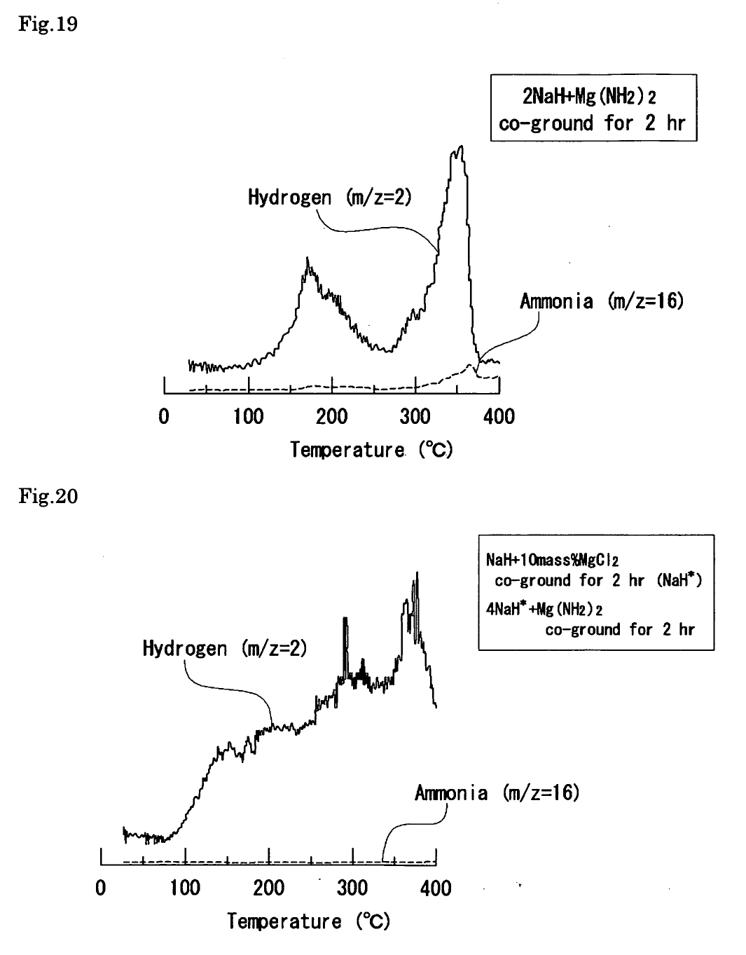

The result of TPD-MS in Comparative example 4 is shown in FIG. 19. Further, the result of TPD-MS in Example 11 is shown in FIG. 20.

From FIGS. 19 and 20, it is obvious:

(1) that even in the case where MgCl₂ as a catalyst is not added (Comparative example 4), hydrogen is generated remarkably at a temperature of 100° C. or higher but a trace of ammonia is observed to be generated; and
(2) that in the case where MgCl₂ is added further to NaH+Mg(NH₂)₂ (Example 11), hydrogen is observed to be generated remarkably from a temperature not higher than 100° C. and the ammonia yield is below the detection limit.

The embodiments according to the present invention have heretofore been explained in detail but the present invention is not limited to the embodiments and can be variously modified within the range not deviating from the tenor of the present invention.

A hydride composite and a preparation process of a hydrogen gas according to the present invention can be used as: a hydride composite/hydrogen storage material used for hydrogen storage means for a fuel cell system, a chemical heat pump, an actuator, a hydrogen storage body for a metal-hydrogen storage cell, and others; and a method for generating the hydrogen gas used for those applications.

What is claimed is:

1. A hydride composite containing NaH and a metal salt containing an alkali earth metal or a transition metal.

2. The hydride composite according to claim 1, wherein the metal salt can form ammine complexes.

3. The hydride composite according to claim 2, wherein the metal salt is MgCl₂.

4. The hydride composite according to claim 3, wherein the content of the MgCl₂ is in the range of 1 mass % to 20 mass %.

5. The hydride composite according to claim 4, wherein the hydride composite is obtained by co-grinding a mixture of the NaH and the MgCl₂ for two minutes to 40 hours.

6. A hydride composite containing NaH, a metal salt containing an alkali earth metal or a transition metal, and an ammonia source that is a solid at ordinary temperatures and generates an ammonia gas by decomposition.

7. The hydride composite according to claim 6, wherein the metal salt can form ammine complexes.

8. The hydride complex according to claim 7, wherein the metal salt is MgCl₂.

9. The hydride composite according to claim 8, wherein the content of the MgCl₂ is in the range of 1 mass % to 20 mass %.

10. The hydride composite according to claim 9, wherein the hydride composite is obtained by co-grinding a mixture of the NaH, the MgCl₂, and the ammonia source for 2 minutes to 40 hours.

11. The hydride composite according to claim 10, wherein the ammonia source is Mg(NH₂)₂.

12. A preparation process of a hydrogen gas including a reaction process to react the hydride composite according to claim 1, with an ammonia gas.

13. The preparation process of a hydrogen gas according to claim 12, wherein the ammonia gas is supplied from an ammonia source that is a solid at ordinary temperatures and generates an ammonia gas by decomposition.

14. A preparation process of a hydrogen gas including a reaction process to heat the hydride composite according to claim 6.
